(19) United States
(12) Patent Application Publication
(10) Pub. No.: US 2015/0172306 A1
(43) Pub. Date: Jun. 18, 2015

(54) METHOD AND APPARATUS FOR ENHANCING SECURITY IN AN IN-VEHICLE COMMUNICATION NETWORK

(71) Applicant: HYUNDAI MOTOR COMPANY, Seoul (KR)

(72) Inventors: Dong Won KIM, Seoul (KR); Soon Seock OK, Hwaseong-si (KR)

(21) Appl. No.: 14/556,089

(22) Filed: Nov. 28, 2014

(30) Foreign Application Priority Data
Dec. 13, 2013 (KR) 10-2013-0155506

(51) Int. Cl. H04L 29/06

(52) U.S. Cl. CPC H04L 63/1425; H04L 63/123

(57) ABSTRACT

A method and apparatus for enhancing security in an in-vehicle communication network using a gateway are provided. The gateway includes a moving average determination module configured to calculate a moving average for a transmission interval of a predetermined number of received messages and to determine whether the received messages are hacking messages by comparing the moving average with a preset maximum allowable latency. The gateway further includes a security code checking module configured to analyze, if any one of the received messages is an aperiodic message, a security code contained in the aperiodic message to determine whether the aperiodic message is a hacking message. Therefore, security in the vehicle may be enhanced.

### CROSS-REFERENCE TO RELATED APPLICATION

This application claims the benefit of the Korean Patent Application No. P10-2013-0155506 filed on Dec. 13, 2013, which is hereby incorporated by reference as if fully set forth herein.

### TECHNICAL FIELD

The present invention relates to a method and apparatus for enhancing security in an in-vehicle communication network and, more particularly, to a method and apparatus for enhancing security in an in-vehicle communication network over which hacking into the vehicle is preventable using a gateway allowing message monitoring.

Background With development of automotive technology, recently released vehicles are provided with more various and complex measurement and sensing functions. Such sensing functions are controlled by an electronic control unit (ECU) of the vehicle.

In addition, the vehicles are provided with a standardized interface, namely an on-board diagnostics (OBD) connector to which an OBD, i.e., a vehicular self-diagnosis system, is connectable. Once the OBD is connected to a vehicle, information—including, for example, vehicle information, a record of travel history, emitted gas information, and error information measured and sensed by various ECUs is sent to the OBD through a predetermined control procedure.

Particularly, as advanced vehicles and consumer safety and comfort are consistently demanded, the number of electronic devices mounted on a vehicle has increased. In this context, a communication network for exchange and share of information between different electronic devices has been treated as a significant issue. Conventionally, communication between a vehicle control system and a sensor has been conducted mainly through wiring based on a point-to-point technique, and accordingly there have been many problems regarding product costs, production time, reliability, and the like.

To address the problems of the conventional vehicle communication network, controller area network (CAN) communication has recently been mainly used to allow microcomputers or devices to communicate with each other in a vehicle without a host computer. CAN communication is a technique with which various ECUs installed in a vehicle are connected to each other in parallel and processing is performed according to preset priorities, and may control various devices using only two wires.

In addition, CAN communication is highly marketable and inexpensive as a message-based standard protocol. Accordingly, many manufacturers are competitively manufacturing CAN chips, which are often used not only in vehicles but also in industrial automation and medical equipment in recent years.

For example, CAN has been introduced in applications for railroad vehicles including, for example, a tram, a subway train, a light-rail train, and an express train. CAN is also used in different levels of various networks in a vehicle. In addition, CAN has also been applied to aircraft applications such as an aircraft state sensor, a navigation system, and a research PC in a cockpit. Moreover, a CAN bus is also used in various aerospace applications ranging from on-aircraft data analysis to an engine control system including, for example, a fuel system, a pump, and a linear actuator.

In addition, manufacturers of medical equipment have employed CAN as an embedded network of the medical equipment. In some hospitals, an operating room is fully managed using CAN. That is, all the apparatuses arranged in the operating room including lights, tables, X-ray machines, and operating tables can be integrally controlled through a CAN-based system. The elevator and the escalator can employ an embedded CAN network, and hospitals can employ the CANopen protocol to connect and control devices such as a panel, a controller, and door safety devices. The CANopen is also used in non-industrial applications such as laboratory equipment, sports cameras, telescopes, automatic doors, and coffer makers.

Particularly, CAN communication can support a transmission speed of up to 1 Megabits per second (Mbps), and also supports relatively long-distance communication. Further, CAN communication is provided with a receive filter, which is capable of selecting only a specific message identifier set in hardware.

Recently, hacking into the vehicle control system frequently occurs using an on-board diagnostics terminal, which is a vehicular self-diagnosis device or a wireless communication terminal such as a smart phone. However, a method and apparatus for effectively preventing hacking have not been introduced yet.

### SUMMARY

Accordingly, the present invention is directed to a method and apparatus for enhancing security in an in-vehicle communication network that substantially obviate one or more problems due to limitations and disadvantages of the related art.

An object of the present invention devised to solve the above problems of the related art lies in a method for enhancing security in an in-vehicle communication network.

Another object of the present invention is to provide a method for enhancing security in an in-vehicle communication network with which hacking into the vehicle is preventable using a gateway, which is capable of monitoring messages.

Another object of the present invention is to provide a method for enhancing security in an in-vehicle communication network with which a hacking message can be identified based on periodic information by performing a predetermined security process with a certain periodicity through a control device connected over a CAN communication channel.

Another object of the present invention is to provide a method for enhancing security in an in-vehicle communication network with which a hacking message and an event message can be identified by inserting a separate security code in one side of an event message to identify an aperiodic event message.

Another object of the present invention is to provide an apparatus, a system and a recording medium for supporting the aforementioned methods.

Additional advantages, objects, and features of the invention will be set forth in part in the description, which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

The present invention provides a method and apparatus for enhancing security in an in-vehicle network.

To achieve these objects and other advantages and in accordance with the purpose of the invention, as embodied and broadly described herein, a method for enhancing security in a gateway configured to communicate with at least one controller, includes performing an authentication procedure with the at least one controller according to an external input signal, sensing, when the authentication procedure is completed, at least one message generated by the at least one controller, checking a periodicity of the message based on a timing point of sensing of the message, and determining whether the message is a hacking message based on the checked periodicity and a moving average for the consecutively sensed message.

Herein, the authentication procedure may include collecting, from the controller having passed the authentication, a message identifier (ID) list used by the controller, wherein, when a message ID not contained in the message ID list is sensed, the sensed message ID may be recorded in a predetermined recording region, and the message containing the registered message ID is blocked.

In addition, the message generated by the controller may include a first message and a second message, the first message being a periodic message and the second message being an aperiodic message.

Herein, a maximum latency of the first message may not exceed a half of a preset transmission period.

In addition, when the message is sensed at every start point of a pre-defined transmission period, the message may be determined to be a periodic message.

In addition, when the message is sensed at a point other than a start point of a pre-defined transmission period, the message is determined to be an aperiodic message.

The method may further include comparing, when the message is determined to be the aperiodic message, a first security code contained in the message with a second security code generated by a predetermined security code generation function using data extracted from the message as an input value, wherein, when the comparison confirms that the security codes do not coincide with each other, the message may be determined to be the hacking message.

The method may further include generating, when the message is determined to the hacking message, a predetermined error frame corresponding to the hacking message.

In addition, the method may further include storing, when the message is determined to the hacking message, a hacking detail corresponding to the hacking message in a predetermined recording region, wherein the hacking detail may include at least one of information about date and time of sensing of the hacking message, information about the controller having generated the hacking message and information about a message identifier (ID) contained in the hacking message.

The first security code may be inserted in one side of a region of a data field of the message, the region not being actually used for data transmission.

The moving average may be an average value of a sum of transmission intervals for at least three consecutively sensed messages.

If the moving average is less than a predetermined maximum allowable latency, it may be determined that the hacking message is included in a corresponding one of the transmission intervals.

The maximum allowable latency may change in accordance with the number of messages or transmission intervals used for the moving average.

The moving average may be calculated every time the message is sensed.

The message may be a controller (CAN) frame.

In another aspect of the present invention, a gateway includes a moving average determination module configured to calculate a moving average for a transmission interval of a predetermined number of received messages and to determine whether the received messages are hacking messages by comparing the moving average with a preset maximum allowable latency, and a security code checking module configured to analyze, if any one of the received messages is an aperiodic message, a security code contained in the aperiodic message to determine whether the aperiodic message is a hacking message, wherein the gateway receives the messages from at least one controller through a controller area network (CAN) bus.

The gateway may further include a message filtering module configured to identify controllers of the at least one controller, to collect a message identifier (ID) list used by the authenticated controllers, and to determine whether the received messages are hacking messages using the collected message ID list, the controllers being authenticated through a predetermined authentication procedure with the at least one controller.

The gateway may further include a memory module, the message ID list being recorded in the memory module.

The gateway may further include a reference timing signal generation module configured to generate reference timing information necessary for periodic message transmission to the at least one controller.

If the moving average is less than the maximum allowable latency, the moving average determination module may determine that a hacking message is included in the transmission interval.

The security code checking module may extract a first security code and data contained in the aperiodic message, compare the first security code with a second security code, and determine, when the security codes do not coincide with each other, that the aperiodic message is the hacking message, the second security code being generated by a predetermined security code generation function using the extracted data as an input value.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, illustrate embodiments of the invention and together with the description serve to explain the principle of the invention. The technical features of the present invention are not limited to specific drawings. The features illustrated in the respective drawings may be combined to construct a new embodiment. In the drawings:

FIG. 1 is a block diagram illustrating a CAN network according to an exemplary embodiment of the present invention;

FIG. 2 illustrates a method for monitoring hacking messages in a gateway using a security procedure according to one embodiment of the present invention;

FIG. 3 illustrates a method for monitoring hacking messages in a gateway using a security procedure according to one embodiment of the present invention;

FIG. 4 illustrates a method for monitoring hacking messages in a gateway using a security procedure according to one embodiment of the present invention;

FIG. 5 illustrates a message structure on the CAN network according to one embodiment of the present invention;

FIG. 6 illustrates a structure of a data field constructed to identify an event message and a hacking message on a CAN network according to one embodiment of the present invention;

FIG. 7 is an internal block diagram illustrating a gateway according to one embodiment of the present invention; and

FIG. 8 is a flowchart illustrating a method for enhancing securing in an in-vehicle communication network according to one embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. The suffix “module” or “unit” used for elements disclosed in the following description is merely intended for easy description of the specification, and the suffix itself does not have any special meaning or function.

A mobile terminal disclosed herein may include a mobile phone, a smartphone, a laptop computer, a digital broadcast terminal, a personal digital assistant (PDA), a portable multimedia player (PMP), a navigation system, and the like. However, it is to be understood by those skilled in the art that configurations according to embodiments disclosed in the following description may be applicable to a stationary terminal such as a desktop computer, excluding the elements configured only for a mobile terminal. Particularly, a mobile terminal according to the present invention may have an ODB function, and may be provided with a means for wired or wireless communication with a gateway.

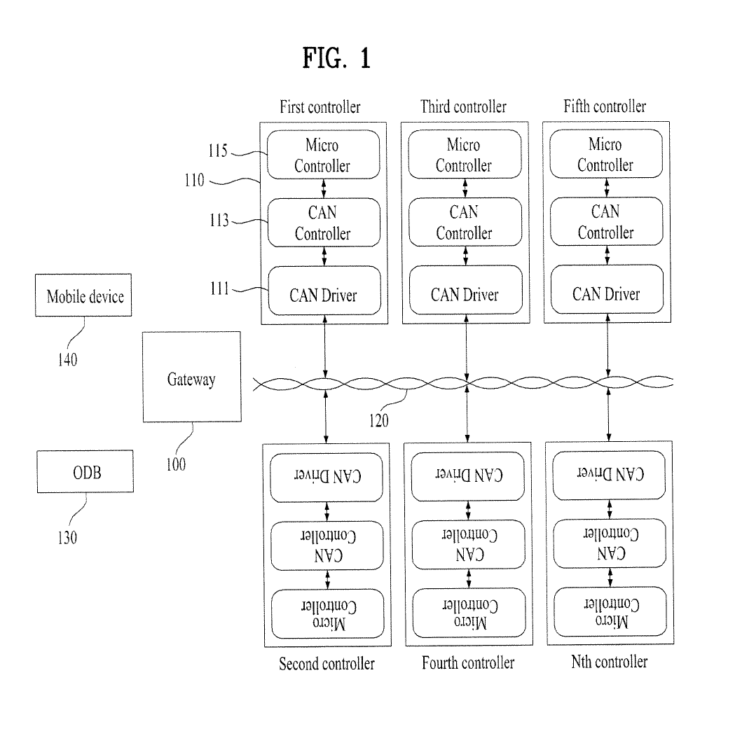

FIG. 1 is a block diagram illustrating a CAN network according to an exemplary embodiment of the present invention

Referring to FIG. 1, the CAN network according to this embodiment may include at least one of a gateway 100, first to Nth controllers, a CAN bus 120, an OBD 130, and a mobile device 140.

The gateway 100 is configured to determine whether a controller is a safe controller through an authentication procedure for the controllers connected to the CAN network. In addition, the gateway 100 is configured to receive a controller-specific message identifier (hereinafter, referred to as message ID) from each of the controllers having passed the authentication procedure and then maintain the same in a predetermined recording region. Thereafter, the gateway 100 is configured to monitor all messages sent over the CAN bus 120. Thereby, when a CAN frame which does not correspond to a pre-received message ID is confirmed, the gateway 100 is configured to generate a predetermined form error indicator for the CAN frame so as to establish a setting that blocks the corresponding device from participating in communication.

For example, a hacker may attempt to access the vehicle network through the gateway 100 using a mobile device 140 or an OBD terminal 130. At this time, the gateway 100 extracts a message ID of a message received from the hacking terminal, and checks whether the extracted message ID is included in the messages collected from existing controllers. If it is determined that the message ID is not included in the collected messages, the gateway 100 is configured to block access from the hacking terminal.

According to another embodiment, to prevent the CAN bus 120 from being overloaded, the gateway 100 is configured to store a message ID list for respective vehicle models and specifications in a predetermined recording region. Thereafter, if an external device, e.g., a hacking terminal requests access to the CAN network through a message other than the pre-stored message IDs, the gateway 100 is configured to block access.

In the above example, the gateway 100 is configured to monitor a message from an external device and block access therefrom such that only message IDs collected from the controllers connected to the CAN bus 120 are loaded on the CAN bus 120. However, if the hacker already knows the message ID used on the CAN network, a hacking message from the hacker terminal may not be effectively blocked. Accordingly, the hacker may install a controller on the CAN network for the purpose of hacking, and generate a hacking message through the installed controller to hack the vehicle information.

To address the problem as above, the gateway 100 according to one embodiment of the present invention is configured to periodically receive a security message from the controllers having passed the predetermined authentication procedure after IG on, which refers to a supply of power to all electric devices after starting of a vehicle, and determine, based the security message, whether a hacking message is received from an installed unauthorized controller.

For example, the controllers connected to the CAN network may sequentially perform the security procedure with a certain period. Herein, the security procedure refers to transmission of a security message. To this end, a predetermined priority for execution of the security procedure may be assigned to each controller, and the controllers may perform the security procedure according to the assigned priorities. Suppose that controller A, controller B, and controller C are connected to the CAN network, with controller B having a higher priority than controller A, and controller C having a higher priority than controller B. When a predetermined time, e.g., 30 seconds elapses after controller C transmits a security message, controller B may send a security message, and 30 seconds thereafter, controller A may transmit a security message.

Herein, the priorities for the controllers may be pre-defined according to vehicle models and specifications and maintained in the controllers. Alternatively, the gateway 100 may allocate priorities to the controllers through a predetermined control procedure.

In the above embodiment, to maintain uniform timing points of start of the security procedure among the controllers, namely, to maintain a uniform period of start of the security procedure among the controllers, timing information to be shared over the CAN network may be needed. To this end, in one embodiment of the present invention, the gateway 100 is configured to generate a predetermined timing signal for sharing of start timing points of the security procedure among the controllers, or a seed value necessary for driving of a timer and transmit the same to the CAN bus 120. The controllers are configured to determine the start timing points of the security procedure using the timing signal on the CAN bus 120 or the seed value. According to another embodiment of the present invention, the controllers are configured to actuate a timer using a global positioning system (GPS) signal received through a GPS receiver provided to the vehicle. That is, since all the controllers connected to the CAN network use the same GPS signal as a timing signal, synchronization between controllers may be maintained.

The CAN bus 120 employs a twisted wire pair, and the two wires are driven by different signals CAN_H and CAN_L. The transmission speed on the CAN bus 120 may depend on the length of the bus.

The first to Nth controllers may be connected to the CAN bus 120 through a predetermined CAN connector. In theory, the maximum number of controllers that can be connected to one CAN network is 2032.

Hereinafter, the structure of the controllers connected to a general CAN will be discussed with reference to reference numerals 110 to 115.

A first controller 110 may include a CAN driver 111, a CAN controller 113, and a microcontroller 115.

The CAN driver 111 is connected to the CAN bus 120 through a predetermined CAN connector, and configures a physical layer of the controller. The CAN driver 111 may function to sense and manage failure of the CAN bus 120 and to transceive messages.

The CAN controller 113 transmits and receives a CAN protocol message and performs message filtering upon received messages. Otherwise, the CAN controller 113 provides functions of a message buffer for retransmission control and interface with the microcontroller 115.

The microcontroller 115 may be provided with a central processing unit (CPU), and may provide a higher layer protocol and various applications.

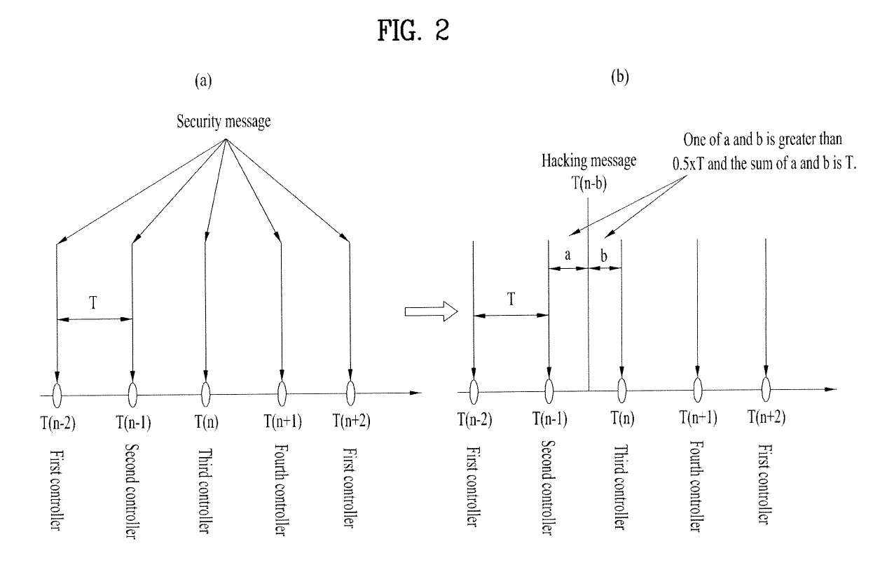

FIG. 2 illustrates a method for monitoring hacking messages in a gateway using a security procedure according to one embodiment of the present invention.

As shown in FIG. 2(a), the gateway 100 is configured to receive a security message from first to fourth messages for which authentication has been completed, during a certain period T. In this case, it is assumed that transmission latency of a security message does not occur between the first to fourth controllers and the gateway 100. Referring to FIG. 2(a), the first to fourth controllers sequentially transmit a security message with period T, and then the first controller transmits the security message again at a timing point T(n+2).

FIG. 2(b) illustrates reception of a hacking message at a time between T(n−1) and T(n) of FIG. 2(a). FIG. 2(b) shows that the hacking message has been received at timing point T(n−b) or T(n−1+a). Herein, one of a and b has a value greater than 0.5*T, and the sum of a and b is T.

As seen in the above example, if two or more messages are received between T(n−2) and T(n), i.e., for 2T, it may be determined that one of the messages is a hacking message. That is, one of the messages received at timing points T(n−1) and T(n−b) may be a hacking message.

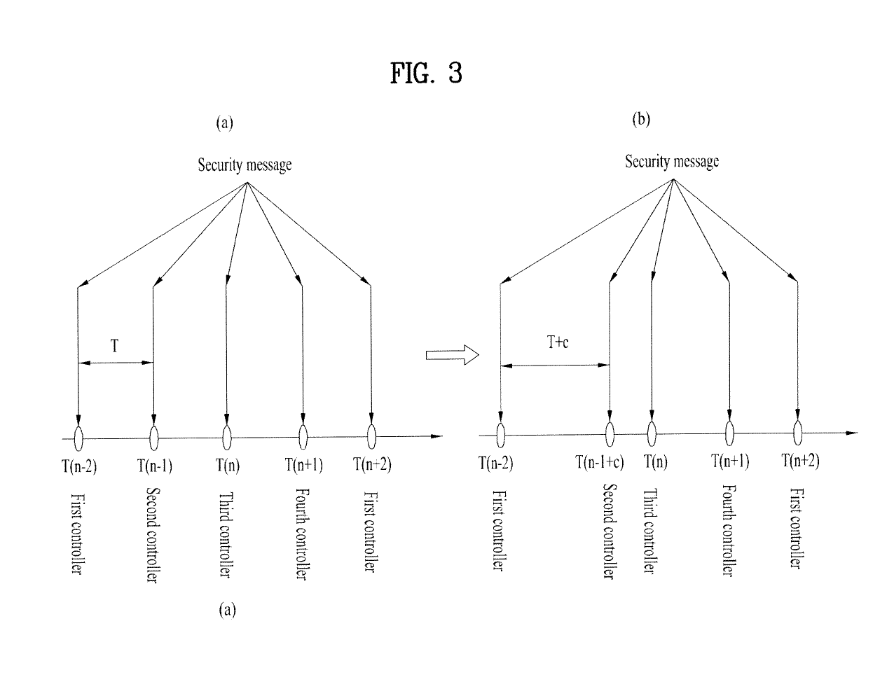

FIG. 3 illustrates a method for monitoring hacking messages in a gateway using a security procedure according to one embodiment of the present invention.

Referring to FIG. 3(b), the security message transmitted from the second controller may be received by the gateway 100 at timing point T(n−1+c) with a time delay of c. Herein, the time delay may be produced due to causes such as overload of the CAN, message collision, and priority control. Thereafter, a security message from the third controller is received by the gateway 100 at timing point T(n). That is, although reception of the security message from the second controller is delayed, three security messages are normally received for 2T.

In general, the maximum latency that can occur on the CAN should occur within 0.5T. If the latency time is greater than or equal to 0.5T, the gateway 100 cannot identify the controller from which a security message is received. Accordingly, it is preferable to set period T to be greater than two times the maximum latency.

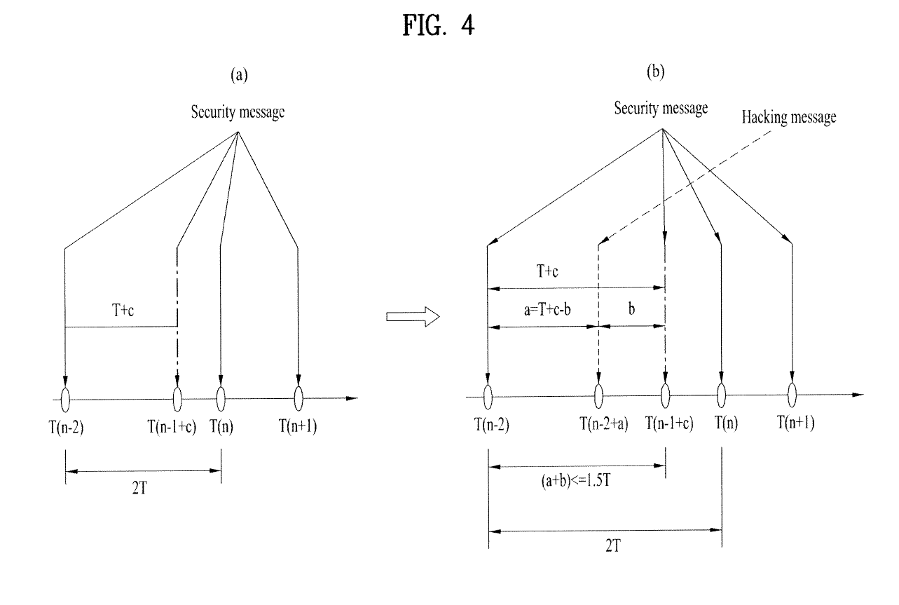

FIG. 4 illustrates a method for monitoring hacking messages in a gateway using a security procedure according to one embodiment of the present invention.

Referring to FIG. 4, in the situation of FIG. 4(a), a hacking message may be received at a timing point between timing points T(n−2) and T(n−1+c). In this case, four messages are sensed by the gateway 100 for period 2T. That is, one of the four messages may include a hacking message.

Hereinafter, a detailed description will be given of a method for identifying which of the four messages included in interval 2T is the hacking message.

First, if a moving average of the total reception interval in which three message are consecutively received is less than or equal to 0.75*T, one of the three messages may be a hacking message.

Referring to FIG. 4(b), the length of the reception interval of the first three consecutive messages from T(n−2) to T(n−1+c) is T+c (c<0.5T). Accordingly, (T+c)/2 is always less than 0.75*T. That is, one of the first three received messages may include a hacking message.

The length of the reception interval of the second three consecutive messages from T(n−2+a) to T(n) is 2T−a. If a>0.5T, one of the three received messages must be a hacking message.

The length of the reception interval of the third three consecutive messages from T(n−1+c) to T(n+1) is 3T−(T+c). Since c is less than 0.5T, 2T−c is always greater than 1.5T. Accordingly, the gateway 100 may determine that a hacking message is not present n the reception interval of the third three consecutive messages.

As discussed above, hacking may be determined by performing moving averaging for the reception intervals of three consecutive messages. Accordingly, presence or absence of a hacking message in a moving average interval may be determined according to Equation (a) below.

$$\frac{( T ( n - 2 ) - T ( n - 1 ) ) + ( T ( n - 1 ) - T ( n ) )}{2} < 0.75 T , \\ ( T = transmission period ) \qquad Equation ( a )$$

Herein, it is assumed that messages are sequentially received at timing points T(n−2), T(n−2), and T(n).

As shown in FIG. 4 and Equation (a), the gateway 100 continuously calculates a moving average using the difference between the previous transmission timing point and the current transmission timing point. If the result of calculation is less than 0.75×T (the maximum allowable latency), it may be determined that a hacking message is present in the interval. Herein, it should be noted that the value of the maximum allowable latency for the two transmission intervals may be adjusted according to system design. Preferably, the maximum allowable latency for the two transmission intervals is set to a value between 0.75T and 0.9T.

According to another embodiment of the present invention, the gateway 100 is configured to adjust the number of messages from which a moving average is estimated and a corresponding maximum allowable latency, such that the security level is adjusted. For example, it may be possible to perform moving averaging for three consecutive transmission intervals and calculate the corresponding maximum allowable latency set to T.

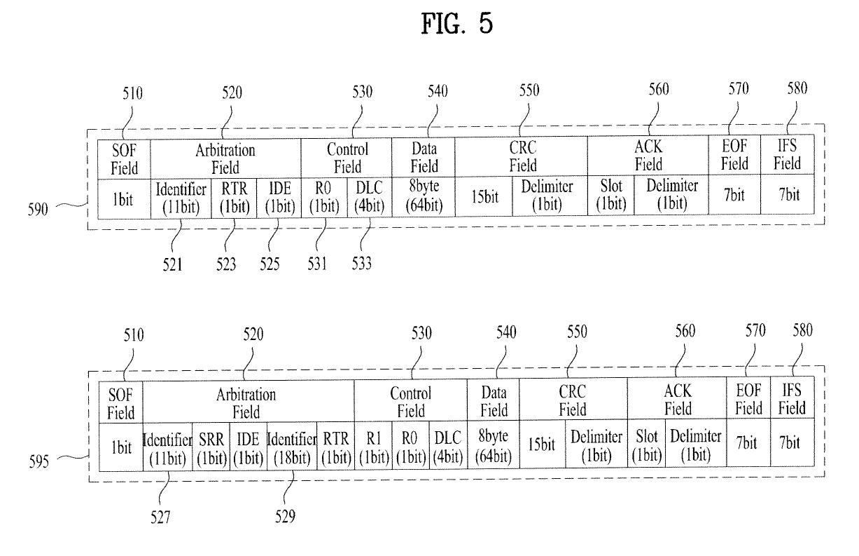

FIG. 5 illustrates a message structure on the CAN according to one embodiment of the present invention.

More specifically, FIG. 5 illustrates a CAN frame structure according to the CAN communication standard.

Referring to FIG. 5, a CAN frame includes a Start-of-Frame (SOF) field 510, an arbitration field 520, a control field 530, a data field 540, a Cyclic Redundancy Check (CRC) field 550, an ACK field 560, an End-of-Frame (EOF) field 570, and an Interframe Sequence (IFS) field 580.

In accordance with one exemplary embodiment of the invention, the SOF field 510 is a field indicating start of a CAN frame, i.e., a message.

The arbitration field 520 identifies a message and assigns a priority to the message. According to a length of an identifier field 521 allocated in the arbitration field 520, the CAN frame is divided into a standard format 590 and an extended format 595. In one exemplary embodiment, for the standard format 590, the length of the identifier field 521 in the arbitration field 520 is 11 bits. For the extended format 595, the length of the identifier field 521 in the arbitration field 520 is 29 bits.

In addition, the arbitration field 520 may include an Identifier Extension (IDE) field 525 having a length of 1 bit to identify whether a frame is the standard format or the extended format. If the value of the IDE field 525 is 0, this indicates the standard format. If the value is 1, this indicates the extended format.

In addition, the arbitration field 520 may include a Remote Transmission Request (RTR) field 523 having a length of 1 bit to identify whether a frame is a remote frame or a data frame. If the value of the RTR field 523 is 0, this indicates the data frame. If the value of the RTR field 523 is 1, this indicates the transmission frame.

The control field 530 includes an RO field 531 and a Data Length Code (DLC) field 533 indicating the length of data in byte.

The data field 540, which is a region in which data is recorded, has a variable length between 0 bytes and 8 bytes.

The CRC field 550 is a field used for error detection. The CRC field 550 is configured with a periodic overlap check code having a length of 15 bits, and a reverse delimiter having a length of 1 bit.

The ACK field 560 is information indicating whether or not a message is normally received at a specific node, and an ACK bit is transmitted at the end of the message by the CAN controllers having accurately received the message. The node having transmitted the message checks whether or not the ACK bit is present on the CAN bus. If ACK is not found, the node may attempt retransmission.

The EOF field 570 indicates an end of a message, the IFS field 580 is a predetermined sequence code inserted to distinguish a frame.

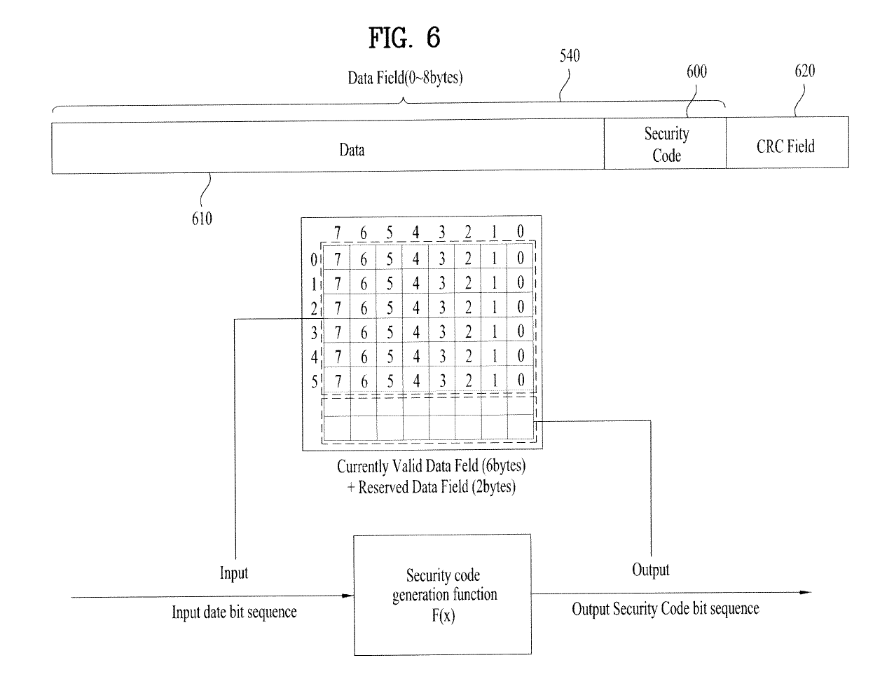

FIG. 6 illustrates a structure of a data field constructed to identity an event message and a hacking message on the CAN according to one embodiment of the present invention.

Generally, a CAN signal in the CAN refers to individual data contained in the data field of a CAN frame. Alternatively, the CAN signal may refer to a channel. As shown in FIG. 6, the data field possesses data up to 8 bytes, and thus a single CAN frame may possess 0 to 64 individual signals or channels. In the case of 64 channels, all the channels are binary signals.

Referring to FIG. 6, only 6 bytes of 48 channels are currently used among 64 channels. 2 bytes of the other 16 channels are a reserved data field for later use.

Unlike the security message of the aforementioned example which is periodically transmitted, a specific message may be instantly produced without periodicity according to occurrence of an event. Hereinafter, for simplicity of description, a normal message having not periodicity will be referred to as an event message.

Particularly, the event message is not transmitted until an even occurs, and thus it is difficult to determine whether or not the message is a hacking message based on the transmission period. However, the gateway 100 according to this embodiment collects, from the controllers, all the message IDs that can be processed by the controllers, or store messages that the corresponding controllers can process in a predetermined recording region according to the vehicle models and specification. Thereby, when the gateway 100 senses a specific aperiodic message on the CAN bus 120, it may identify whether or not the message is an event message or a hacking message based on the stored message ID information.

However, if the hacker already knows the event message, the hacking message may include a message ID corresponding to the normal event message. In this case, the gateway 100 may determine that the hacking message is a normal event message. Accordingly, in this case, an enhanced security means is needed to block the hacking message.

The aforementioned event message is very similar to a general hacking message in terms of aperiodicity. Accordingly, a predetermined security code 600 may be added to one side of the data field 540 to certainly identify a hacking message and a event message. In this case, all or a part of the reserved data field may be used for the security code 600.

The security code 600 may be created based on data 610 of the data field 540 using a pre-defined security map, which may employ, for example, a block code or a generation function. Herein, the security map is stored in a controller using the event message and the gateway 100, respectively.

Hereinafter, a brief description will be given of the procedure of creation of a security code in a controller using a generation function (F(x)) as the security map, with reference to FIG. 6.

The controller may read valid data, which may have a length of 6 bytes, included in the data field 540 and use the data as an input value of a predetermined security code generation function F(x). Then, the output value produced through F(x) is recorded in a security code field 600. Thereafter, the controller transfers an event message containing the security code onto the CAN bus 120.

When the gateway 100 senses the event message on the CAN bus 120, gateway 100 receives the event message, and reads the valid data out of the data field 540 of the received event message. The read valid data is used as an input value for F(x). Thereafter, the gateway 100 checks whether the value output by F(x) coincides with the value of the security code contained in the event message. If the checking confirms that the values coincide, the gateway 100 determines that the event message is a normal message. If the checking confirms that the values do not coincide, the gateway 100 may determine that the event message is a hacking message. Herein, the length of the security code may depend on the order of F(x). It should be noted that the created security code is included when a CRC value is created and recorded in the CRC field 620, as shown in FIG. 6(a).

When the gateway 100 senses an event message on the CAN bus 120, gateway 100 is configured to check conformity of the data and security code of the message and determine whether the event message is a normal message. At this time, checking the conformity of the security code is a procedure of determining whether a value calculated using the security map and the data value coincides with the security code contained in the message. If they do not coincide, the gateway 100 generates a predetermined form error signal and block transfer of the message to the controllers.

According to another embodiment of the present invention, when the gateway 100 senses a hacking message through the above embodiments, gateway 100 is configured to transmit, to a preset contact number, e.g., a cell phone number of the owner of the vehicle, a predetermined warning message informing the owner that hacking into the vehicle has been sensed.

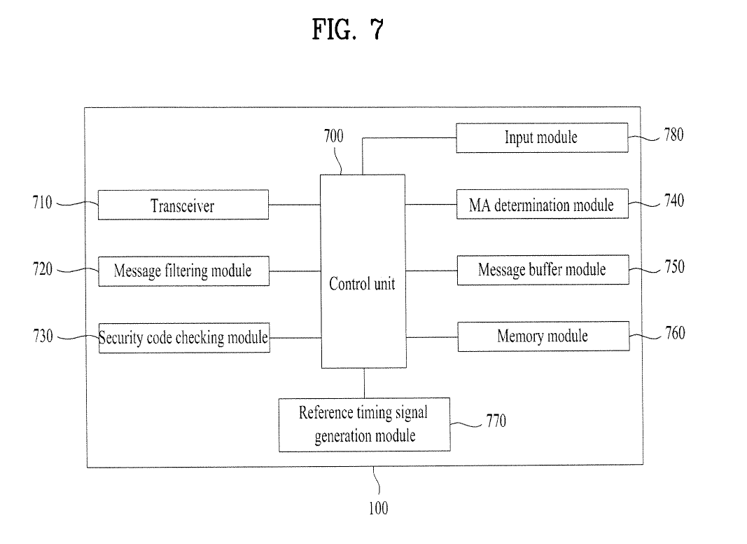

FIG. 7 is an internal block diagram illustrating a gateway according to one embodiment of the present invention.

Referring to FIG. 7, the gateway 100 may include a control unit 700, a transceiver 710, and a sub-module including at least one of a message filtering module 720, a security code checking module 730, a moving average determination module 740, a message buffer module 750, a memory module 760, and a reference timing signal generation module 770.

The control unit 700 controls input/output in the gateway 100 and also controls operation of the sub-module.

The transceiver 710 performs communication with an external device including, for example, a mobile device and an OBD terminal, and is connected to CAN bus 120 to receive a CAN frame present on the CAN bus 120 and to transfer a CAN frame created by the control unit 700 onto the CAN bus 120. In addition, the transceiver 710 may also transmit, to the controllers connected to the CAN bus 120, a signal created by the reference timing signal generation module 770 according to a control signal of the control unit 700.

In addition, the transceiver 710 senses whether the transmitted CAN frame has been normally transferred to a receive controller, and is configured to start a retransmission procedure depending upon the result of sensing.

At this time, the transmitted CAN frame may be maintained in the message buffer module 750 until an ACK signal from the receive controller is sensed. If the ACK signal is sensed, the CAN frame may be deleted from the message buffer module 750.

The message filtering module 720 functions to filter a message received through the transceiver 710. Herein, filtering may be a procedure of extracting an identifier, i.e., reference numeral 521 (standard format) or a combination (extended format) of reference numerals 527 and 529, and checking whether the extracted identifier is included in the message ID list pre-collected from the controllers.

In the filtering step, if the extracted identifier is included in the message ID list, the message filtering module 720 may determine that the CAN frame is a normal message. On the other hand, if the extracted identifier is not included in the message ID list, the message filtering module 720 is configured to determine that the CAN frame is a hacking message and notify the control unit 700 of the determination. Subsequently, the control unit 700 is configured to generate a predetermined form error signal and block the device having generated the message from accessing the CAN.

In addition, the message filtering module 720 is configured to collect, from the controllers authenticated through an authentication procedure, a message ID list used by the controllers according to a control signal from the control unit 700, and store the same in the memory module 760.

According to another embodiment, the message filtering module 720 is configured to determine whether the message is a periodic message or an aperiodic message by comparing the timing point of sensing the message with the start point of a pre-defined transmission period. That is, a message received at the start point of each transmission period may be determined to be a periodic message, and a message received between the start points of the transmission periods may be determined to be an aperiodic message.

The security code checking module 730 functions, upon receiving an aperiodic event message, to analyze a security code contained in the message and then to determine whether the event message is a normal event message or a hacking message. Specifically, upon receiving an aperiodic message, the security code checking module 730 reads data in the data field 540 and a first security code out of the CAN frame. Thereafter, the security code checking module 730 uses the read data as an input value to a predetermined security code generation function F(x) and generates a second security code as an output value of F(x). Thereafter, the security code checking module 730 checks whether the first security code is identical to the second security code, thereby determining whether the received message is a normal event message or a hacking message. That is, if the two security codes coincide, it may be determined that the message is a normal event message. If the security codes do not coincide, it may be determined that the message is a hacking message.

The moving average determination module 740 functions to calculate the timing point of reception or sensing of a message from the CAN bus 120, perform moving averaging for a predetermined number of consecutive message reception intervals and determine hacking by comparing the moving average with a predetermined maximum allowable latency. For example, if a moving average of three consecutive message reception intervals is less than 0.75T, the moving average determination module 740 may determine that at least one of the three messages is a hacking message. For the details of the operation, refer to the description of FIG. 4.

The message buffer module 750 is a recording region where a received message is temporarily stored. The message buffer module 750 is configured to have a recording region of a data structure such as an array or a queue, and the messages may be stored in the message buffer module 750 in a time sequence.

A message ID list for each controller may be stored in the memory module 760.

The reference timing signal generation module 770 provide, to the controllers connected to the CAN and the gateway 100, time information necessary for periodic transmission of security messages.

According to anther embodiment of the present invention, the gateway 100 may further include an input module 780 that receives a pre-registered message ID list for each vehicle type and specification that is externally input or that allows a user to set control parameters necessary for calculation of a moving average. Herein, the control parameters may include a transmission period T of a security message, information about the number of messages used in moving averaging, and maximum allowable latency information that is compared with the calculated moving average to determine whether the message is a hacking message. The user may set the control parameters using a device such as an OBD terminal and a smart phone having an OBD function.

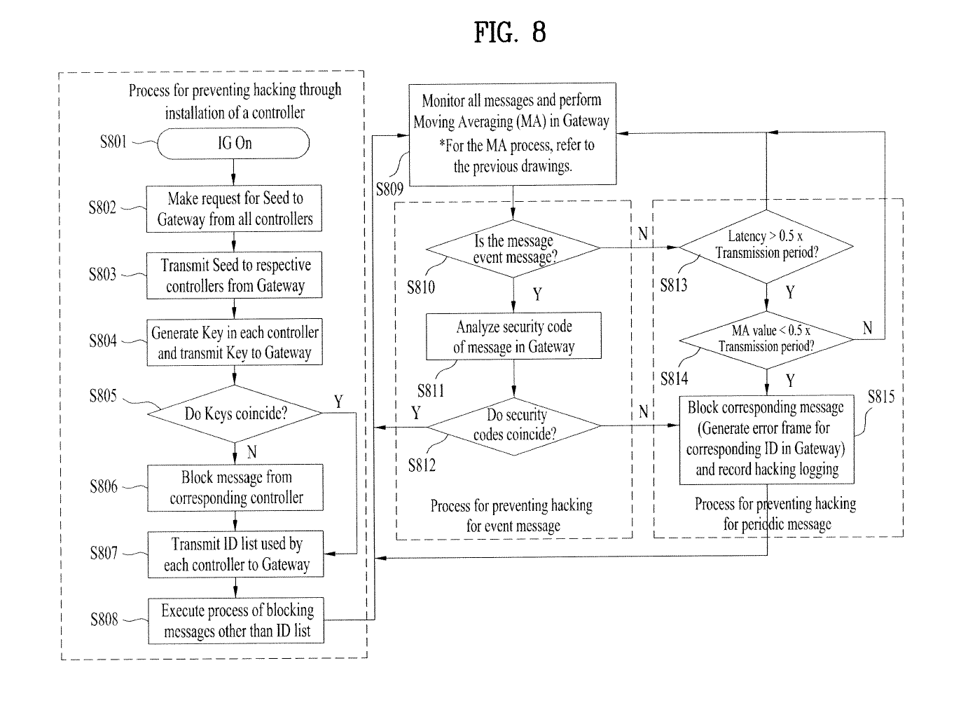

FIG. 8 is a flowchart illustrating a method for enhancing securing in an in-vehicle communication network according to one embodiment of the present invention.

More specifically, FIG. 8 is a flowchart illustrating alogic for blocking of a hacking message by the gateway 100.

Referring to FIG. 8, when the gateway 100 enters the IG On state, the gateway 100 receives messages of request for a seed value from al controllers operatively connected through the CAN (at Steps S801 and S802).

The gateway 100 generates a seed value for each controller, and transmits the generated seed values to the controllers respectively (at Step S803). At this time, the seed values for the respective controllers are stored in a predetermined memory.

Each controller generates a key value using the received seed value, and transmits the generated key value to the gateway 100 (at Step S804).

The gateway 100 checks if the received key value received from a corresponding controller coincides with a key value generated using the seed value transmitted to the controller (at Step S805).

When the checking confirms that the key values coincide, the gateway 100 collects a message ID list used by the controllers through a predetermined control procedure (at Step S807). Then, the message ID list collected from the controllers is stored in a predetermined recording region.

Thereafter, the gateway 100 blocks a message having a message ID not included in the collected message ID list collected from the controllers from entering the CAN (at Step S808). That is, the gateway 100 is configured to primarily block a message having a message ID other than the message IDs registered by the controllers having completed authentication from being transferred to a specific controller on the CAN.

In step S805, if the key values do not coincide, the gateway 100 blocks all the messages generated from the corresponding controller that has transmitted the key value (S806). That is, messages may be controlled such that a message generated by a controller having failed the authentication is not present on the CAN bus 120.

Generally, the key value used in the authentication procedure may be generated by a predetermined key generation function which is pre-shared by the controllers and the gateway 100.

If the hacker finds out the key generation function and overhears a transmitted seed value, a specific controller or hacker terminal installed by the hacker may also pass the authentication procedure. Accordingly, an enhanced security procedure may be required.

Hereinafter, an enhanced method for preventing hacking will be described in detail.

After the above step, the gateway 100 monitors all the messages sensed on the CAN bus 100, performs the moving averaging based on the arrival times of the messages which are sequentially received (at Step S809). For the details of the moving averaging, refer to the description in relation to FIG. 4.

When a message is received, the gateway 100 determines whether the received message is an event message (at Step S810). Herein, whether the message is an event message, the message may be determined by checking whether the message is a periodic message. That is, if the message is periodic, the gateway 100 is configured to determine that the message is a security message. If the message it aperiodic, the gateway 100 is configured to determine that the message is an event message. In another example, an event message may also be identified through a message ID 521 contained in the arbitration field 520. To this end, the gateway 100 is configured to keep predetermined information for identifying whether each of the pre-collected message IDs used for the controllers is periodic or aperiodic.

If it is determined that the message is an event message, the gateway 100 extracts a first security code and data from the received message. Thereafter, the gateway 100 generates a second security code for the extracted data, through a pre-stored security map. Subsequently, the gateway 100 compares the extracted first security code and with the generated second security code (at Steps S811 and S812).

If the comparison confirms that the security codes are identical, the gateway 100 returns to step S809. If the comparison confirms that the security codes are not identical, the gateway 100 blocks the event message, generates an error frame corresponding to the event message, and records a hacking log (at Step S815). At this time, the generated error frame may be transferred to a controller through the CAN bus 120. However, the controller is configured to discard the received message rather than internally processing the message since the received message is the error frame. Thereafter, the controller is configured to record a hacking detail in a predetermined recording region. At this time, time, date, a hacking message ID, identification information about the controller having generated the hacking message, and the like may be recorded in the hacking detail. According to another embodiment, through a predetermined message, the gateway 100 is configured to transfer, to the controllers, predetermined information, including, for example, the hacking message ID and identification information about the controller having transmitted the hacking message, which informs that there has been a hacking attempt

In step S810, if the message is not an event message, namely, if the message is a periodic message, whether the latency is greater than 0.5*T is checked (S813). Herein, the latency may be defined as an absolute value of a difference between a transmission period according to the pre-defined standard and a transmission period according to reception of a message. Accordingly, if a hacking message is received during one transmission period T, one of the latencies between two normal periodic messages and the hacking message is greater than 0.5*T.

If the checking confirms that the latency is greater than 0.5*T, it is checked whether the moving average between two consecutive transmission intervals calculated in step S809 is less than 0.75*T (S814).

If the checking confirms that the moving average is less than 0.75*T, the gateway 100 performs step S815, and then returns to step S809.

In step S814, if the moving average between two consecutive transmission intervals is greater than or equal to 0.75*T, the gateway 100 determines that messages received in the corresponding transmission interval do not include a hacking message, and returns to step S809.

As apparent from the above description, the present invention has effects as follows.

First, according to embodiments of the present invention, a hacking message may be effectively identified and blocked in an in-vehicle communication network supporting CAN communication. Thereby, hacking into vehicle controllers may be prevented.

Second, with a method for enhancing security in an in-vehicle communication network according to one embodiment of the present invention, hacking into the vehicle may be prevented using a gateway capable of monitoring all messages on the CAN communication network.

Third, according to one embodiment of the present invention, as a control device connected over a CAN communication channel periodically performs a predetermined security process, security may be enhanced in an in-vehicle communication network by identifying a hacking message based on periodic information.

Fourth, according to one embodiment of the present invention, by inserting a separate security code in one side of a CAN frame to identify an aperiodic event message, a hacking message and an event message may be effectively identified.

Lastly, according to one embodiment of the present invention, by upgrading software of an existing gateway, security in an in-vehicle communication network may be enhanced without additional hardware cost.

It will be appreciated by a person skilled in the art that the effects and advantages that can be achieved through the embodiments of the present invention are not limited to those described above and other effects and advantages of the present invention will be clearly understood from the following detailed description.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A computer-implemented method for enhancing security in a gateway configured to communicate with at least one controller, the method comprising:
performing an authentication procedure with the at least one controller according to an external input signal;
sensing, when the authentication procedure is completed, at least one message generated by the at least one controller;
checking a periodicity of the at least one message based on a timing point of sensing of the message; and
determining whether the at least one message is a hacking message based on the checked periodicity and a moving average for a consecutively sensed message.

2. The computer-implemented method according to claim 1, wherein the authentication procedure comprises: collecting, from the controller having passed the authentication, a message identifier (ID) list used by the controller,
wherein when a message ID not contained in the message ID list is sensed, the sensed message ID is recorded in a predetermined recording region, and a message containing a registered message ID is blocked.

3. The computer-implemented method according to claim 1, wherein the at least one message generated by the controller comprises a first message and a second message, the first message being a periodic message and the second message being an aperiodic message.

4. The computer-implemented method according to claim 3, wherein a maximum latency of the first message does not exceed a half of a preset transmission period.

5. The computer-implemented method according to claim 1, wherein, when the at least one message is sensed at every start point of a pre-defined transmission period, the at least one message is determined to be a periodic message.

6. The computer-implemented method according to claim 1, wherein, when the at least one message is sensed at a point other than a start point of a pre-defined transmission period, the at least one message is determined to be an aperiodic message.

7. The computer-implemented method according to claim 6, further comprising comparing, when the at least one message is determined to be the aperiodic message, a first security code contained in the message with a second security code generated by a predetermined security code generation function using data extracted from the at least one message as an input value,
wherein, when the comparison confirms that the security codes do not coincide with each other, the at least one message is determined to be the hacking message.

8. The computer-implemented method according to claim 7, further comprising: generating, when the at least one message is determined to the hacking message, a predetermined error frame corresponding to the hacking message.

9. The method according to claim 7, further comprising: storing, when the at least one message is determined to the hacking message, a hacking detail corresponding to the hacking message in a predetermined recording region,
wherein the hacking detail comprises at least one of information about date and time of sensing of the hacking message, information about the controller having generated the hacking message and information about a message identifier (ID) contained in the hacking message.

10. The computer-implemented method according to claim 7, wherein the first security code is inserted in one side of a region of a data field of the at least one message, the region not being actually used for data transmission.

11. The computer-implemented method according to claim 1, wherein the moving average is an average value of a sum of transmission intervals for at least three consecutively sensed messages.

12. The computer-implemented method according to claim 11, wherein, if the moving average is less than a predetermined maximum allowable latency, determining that the hacking message is included in a corresponding one of the transmission intervals.

13. The computer-implemented method according to claim 12, wherein the maximum allowable latency changes in accordance with a number of messages or transmission intervals used for the moving average.

14. The computer-implemented method according to claim 1, wherein the moving average is calculated every time the at least one message is sensed.

15. The method according to claim 1, wherein the at least one message is a controller area network (CAN) frame.

16. A gateway comprising:
a moving average determination module configured to calculate a moving average for a transmission interval of a predetermined number of received messages and to determine whether the received messages are hacking messages by comparing the moving average with a preset maximum allowable latency; and
a security code checking module configured to analyze, if any one of the received messages is an aperiodic message, a security code contained in the aperiodic message to determine whether the aperiodic message is a hacking message,
wherein the gateway receives the messages from at least one controller through a controller area network (CAN) bus.

17. The gateway according to claim 16, further comprising a message filtering module configured to identify controllers of the at least one controller, to collect a message identifier (ID) list used by the identified controllers, and to determine whether the received messages are hacking messages using the collected message ID list, the controllers being authenticated through a predetermined authentication procedure with the at least one controller.

18. The gateway according to claim 17, further comprising a memory module, the message ID list being recorded in the memory module.

19. The gateway according to claim 16, further comprising a reference timing signal generation module configured to generate reference timing information necessary for periodic message transmission to the at least one controller.

20. The gateway according to claim 16, wherein, if the moving average is less than the preset maximum allowable latency, the moving average determination module determines that a hacking message is included in the transmission interval.

21. The gateway according to claim 16, wherein the security code checking module extracts a first security code and data contained in the aperiodic message, compares the first security code with a second security code, and determines, when the first and second security codes do not coincide with each other, that the aperiodic message is the hacking message, the second security code being generated by a predetermined the security code generation function using the extracted data as an input value.
